(19) United States
(12) Patent Application Publication
(10) Pub. No.: US 2005/0272861 A1
(43) Pub. Date: Dec. 8, 2005

(54) Microgel composition and process for preparation thereof

(76) Inventors: Greg Guanghua Qiao, Doncaster East (AU); David Henry Solomon, Murrumbeena (AU); Paul Andrew Gurr, Box Hill North (AU); Martin Frederick Mills, Ashfield (AU)

Correspondence Address: NORRIS, MCLAUGHLIN & MARCUS, 875 THIRD AVE, 18TH FLOOR, NEW YORK, NY, 10022, US

(21) Appl. No.: 11/138,725

(22) Filed: May 26, 2005

(30) Foreign Application Priority Data
Nov. 27, 2002 (AU) 2002953359

(51) Int. Cl. C08K 3/20

(52) U.S. Cl. 524/591

(57) ABSTRACT

The invention relates to a microgel composition comprising microgel particles of weight average molecular weight above 50,000 wherein a 60% w/w solution of the microgel in dioxane has a viscosity of less than 10 Pa.s measured by cone and plate viscometry.

### FIELD

The present invention relates to a microgel composition, to a coating composition containing a microgel binder component and processes for the preparation of microgels and coating compositions.

### BACKGROUND

Microgels are macromolecules which possess a combination of very high molecular weight and a solubility and viscosity similar to linear or branched polymers of relatively low molecular weight. Microgels are an intermediate structure between conventional linear or branched polymers such as polyethylene or polycarbonate and networks such as vulcanised natural rubber. The dimensions of microgels are compatible with high molecular weight linear polymers but their internal structure resembles a network.

The properties of microgels make them particularly useful in a wide range of applications such as in additives, in advanced material formulations for foams or fibres, in coating compositions, binders and redispersible latexes. Microgels may also be used to improve the ease of processing and to improve the structural strength and dimensional stability of the final products. A further potential use for microgels is as additives for high impact polymers. Microgels embedded in a matrix of conventional linear polymer may act to stabilise the whole structure by distributing mechanical tension. Microgels are also useful in biological systems and as pharmaceutical carriers.

Thermosetting coatings and thermoplastic coatings are well known. Thermoplastic coatings contain at least one polymer with sufficiently high molecular weight to provide the required mechanical strength properties without further polymerisation. Thermosetting coatings, on the other hand contain lower molecular weight polymers and are further polymerised after application to achieve the desired properties. A problem with each of these types of coatings has been the need to use significant amounts of solvent for efficient spray application. While volatile organic content of compositions is an important safety and environmental consideration their use has been required to reduce the viscosity sufficiently to allow spray application. This is particularly a problem in automotive coatings and applications such as automotive refinishing.

A number of methods have been used for the preparation of microgels, however these methods generally have a number of serious deficiencies. For example, extreme care is required in preparing microgels as the multiple double bonds present within these systems may readily undergo intermolecular reactions which can lead to intractable networks. Other procedures such as those described by OKay, O. and Funke, W. in MACROMOLECULES, 1990, 23 at 2623-2628 require high purity solvent and reagents as well as an inert atmosphere and are complicated by undesirable side reactions. Despite the unique properties of microgels the difficulties in preparing them have limited their potential and commercial use.

Our copending application PCT/AU98/00015 discloses a process for microgel preparation involving reacting an alkoxy amine with a cross-linking agent in two steps.

The first step involves formation of a linear pre-polymer by using nitroxide mediated controlled polymerization methodology.and the second step involves crosslinking of these pro-polymers on their one living ends using crosslinking agents such as a multi-olefin to form star-shaped microgels. The microgel formation step is also a controlled polymerization process as the incorporation of crosslinking agent going through the radicals formed from nitroxide-capped living prepolymer by dissociation of the nitroxide capping groups.

Our further co-pending International Applications, PCT/Au99/00345 and U.S. Pat. No. 6,355,718, expanded this work to a broad range of controlled polymerization methods. Again a two step procedure involve a first step of providing a living pre-polymer by a controlled polymerization methods and a second step polymerizing these living radicals together with a crosslinking monomer to form microgels. Example of the living polymerization methods include ATRP, RAFT or other living free radical polymerization methods.

The microgels produced by the controlled polymerization will give defined star-shape structures. The length and the number of the arms, size and density of the cores can be controlled by the length of pre-polymers, polymerization formulations and other reaction conditions.

We have now developed a microgel which allows high loadings of polymer to be used in the binder of coating compositions.

### SUMMARY

The invention provides a microgel composition comprising microgel particles of weight average molecular weight above 50,000 wherein a 60% w/w solution of the microgel in dioxane has a viscosity of less than 10 Pa.s measured by cone and plate viscometry. The intrinsic viscosity of the microgel is typically no greater than 0.5 g/dL measured by Viscotek Viscometer. The intrinsic viscosity, when measured by capillary viscometry is generally below 1 dL/g.

In a further aspect the invention provides a coating composition comprising a binder and a liquid carrier wherein the binder comprises a microgel as hereinbefore described and the microgel is dissolved in the liquid carrier.

The invention in a further aspect provides a method for preparing a microgel composition comprising
(i) providing a monomer composition comprising a monounsaturated monomer and a multiunsaturated cross-linking monomer as a solution in an organic solvent, and
(ii) polymerizing the monomer by free radical solution polymerisation wherein the reactivity ratio of the monounsaturated monomer is significantly different from the multiunsaturated monomer and the concentration of the monomer component and the proportion of cross-linking mononer in said monomer composition is controlled whereby a solution of discrete microgel particles of weight average molecular weight of at least 50000 is formed.

The proportion of multi-unsaturated monomer is typically less than 20% by weight of the total monomer component and more preferably less than 15% of weight of the total monomer component.

Most preferably the crosslinking monomer is in the range of from 0.1 to 15% by weight of the total monomer.

The total monomer concentration is typically from 5 to 50% by weight, more preferably from 10 to 50%, still more preferably from 20 to 45% and most preferably 25 to 45% by weight.

The present invention further provides a microgel coating composition comprising:
(i) a polymer comprising one or more reactive functional groups; and
(ii) a crosslinking agent adopted to crosslink the functional groups of the polymer
   wherein the composition includes a microgel as hereinbefore described. The microgel may be said polymer comprising a reactive functional group or a separate component.

### DETAILED DESCRIPTION

The invention provides in one aspect a microgel composition comprising microgel particles of weight average molecular weight above 50,000 wherein a 60% w/w solution of the microgel in dioxane has a viscosity of less than 10 Pa.s measured by cone and plate viscometry.

The weight average molecular weight of the microgel is preferably at least 100,000, more preferably at least 200,000, still more preferably at least 500,000 and most preferably at least 1,000,000.

The size of the microgel particles of the invention, notwithstanding their high molecular weight is typically less than 200 nm in diameter and preferably less than 100 nm. The size is generally measured by standard GPC methods.

The preferred intrinsic viscosity (by Viscotek Viscometry) is less than 0.3. The preferred intrinsic viscosity (by capillary viscometry) is less than 0.5 and for a solution of the microgel in a 60% solution in dioxane is less than 2 Pa.s, even more preferably less than 1.5 Pa.s. and most preferably less than 1 Pa.s.

Microgels formed in accordance with the process of the invention provide surprisingly unusually rheological properties. For a normal linear polymer, viscosity of a polymer solution is proportional to its molecular weight (MW). That means that with the increase of MW, the viscosity of the polymer will increase. However, we found, those star-shaped microgels behave very differently. The viscosity of a star microgel solution is not proportional to its molecular weight. When MW of the microgel increased from 300K to 1.2 million, the intrinsic viscosity of the solution kept constant at about 0.2 g/dl. Such behaviour is unusual and can provide huge effect in the application of these materials in coating or drug delivery. High molecular weight polymer normally gives better mechanical properties for a coating; however, dilution is normally needed due to its high viscosity. With microgel described here, a low viscosity solution can be achieved at high solid content. Consequently, better coating can be made and less solvent is need for the coating process. In drug delivery, the low viscosity functionalized star microgel can provide a medium for adsorption of drug molecules and release them over time during their application.

In a further aspect the invention provides a coating composition comprising a binder and a liquid carrier wherein the binder comprises a microgel as hereinbefore described and the microgel is dissolved in the liquid carrier.

The liquid carrier is preferably an organic solvent. The preferred organic solvents are selected from the group consisting of aromatic hydrocarbons such as naphthalene, xylene and toluene; alcohols such as isopropyl alcohol (IPA); and n-butyl alcohol; aliphatic hydrocarbons such as heptane and mineral spirit; ketones such as methyl ethyl ketone and MIEK; and heterocycles such as tetrahydrofuran and dioxane.

The microgel will typically be present in an amount of from 5 to 90% by weight of the composition with from 20 to 80% being preferred.

The microgel will typically comprise a crosslinked core and arms appended to the core. The core is formed from a multiunsaturated monomer and the arms are generally formed from a monounsaturated monomer.

The coating composition preferably includes a second component comprising a crosslinking agent reactive with the binder. The crosslinker may be reactive with functional groups present in the microgel or with additional components of the binder. The crosslinker component may for example be a di or polyisocyanate, a diepoxy monomer, an amino resin or siloxane. The reactive groups in the binder may be hydroxyl, amine, carboxyl, alkoxysilane, carbamate or combination of these.

The more preferred coating compositions also comprise a further polymeric binder selected from thermoplastic polymer and thermosetting polymers. Binders are primarily responsible for the quality of the film. Examples of polymeric binders include alkyds, polyesters, amino resins such as melamine-formaldehyde, acrylics, epoxies and urethanes.

In order to be applied to a substrate, most coating systems require the use of a solvent to adjust the viscosity such that it is suitable for the application procedure. The viscosity requirement for most applications is in the range of 0.5 to 10 P. This may be influenced by variables such as temperature, structure and solvent-binder interactions. Pigments within the coating compositions are generally used to confer opacity and colour to the coating.

The additional binder may be thermoplastic or thermosetting in character. Thermoplastic coatings utilise high molecular weight polymers to confer desirable mechanical properties to the coatings, such as film strength, hardness and durability. The use of high molecular weight polymers usually means that the coating compositions have a low solids content due to the requirement of reducing the viscosity to a sufficient level for the required application.

Thermosetting polymer coatings on the other hand, utilise low molecular weight reactants that can be further cured or crosslinked to form a high molecular weight polymer after application of the coating to a substrate. The mechanical properties of the film depends upon the T_{g} (glass transition temperature) of the resultant polymer, as well as its crosslinking density.

Thermosetting polymer binders may comprise resins selected from the group consisting of alkyds, polyesters, amino-resins such as melamine formaldehyde resins, acrylic resins, epoxy resins and urethanes.

Coatings based on acrylic resin bindings and/or urethane resin binders containing the microgel of the invention are particularly suited to preparation for use as e.g. automotive and industrial coatings. The use of the microgel of the invention allows the solids content of the coating compositions to be significantly increased while maintaining the relatively low viscosity required for spray application.

The microgel, other binder component (where present) or both comprise groups such as hydroxyl, amine, alkoxysilane and carboxyl which may result in the composition reacting in the crosslinking process to cure the coating. The optional functional group may be present in the crosslinked or pendant arms of the microgel. The concentration and the positioning of the functional groups will influence the reactivity of the microgel. In particular where functional groups are present in the core this will reduce the rate of reaction providing increased pot-life after mixing of polymer and crosslinking components of the binder.

The coating composition may in this way utilise a range of crosslinking systems such as hydroxy/melamine, hydroxy isocyanate epoxy acid, epoxybamine and carbamate/melamine. Preferably the functional group containing polymer and microgel are dissolved or dispersed in an organic solvent. The crosslinking component may if desired also be dissolved or dispersed in an organic solvent.

The coating composition of this embodiment may be a multicomponent system. One component may contain the hydroxyl containing polymer and microgel binder system, preferably the organic solvent and optionally other component such as pigments and fillers, auxiliaries and additives. Another component may contain the crosslinking agent selected from the group consisting of di and/or polyisocyanate; epoxide compounds having at least two epoxide groups per molecule; amino resins; and siloxane crosslinkers.

The coating composition may be in two-pack form, that is, it may include two components stored separately and mixed up to a few hours prior to use or during application.

In this embodiment one pack comprises the binder component and the other the cross-linker. Typically the binder component will comprise 50 to 90% by weight of the coating composition (more preferably 65 to 90%) and the crosslinker components will comprise from 10 to 50% by weight of the coating composition.

Preferred hydroxyl moieties in the binder component are derived from hydroxy monomers, such as hydroxy alkyl acrylates and (meth)acrylates wherein the alkyl group has the range of 1 to 4 carbon atoms in the alkyl group. Exemplars include hydroxy ethyl (meth)acrylate, hydroxy propyl (meth)acrylate, hydroxy butyl (meth)acrylate or a combination thereof.

The monomer mixture which may be used in preparation of an acrylic binder preferably includes one or more monomers selected from alkyl acrylates and corresponding (meth)acrylates having 1-18 carbon atoms in the alkyl group, such as methyl (meth)acrylate, ethyl (meth)acrylate, propyl (meth)acrylate, isopropyl (meth)acrylate, butyl (meth)acrylate, pentyl (meth)acrylate, hexyl (meth)acrylate, 2-ethyl hexyl (meth)acrylate, nonyl (meth)acrylate, lauryl (meth)acrylate, stearyl (meth)acrylate; cycloaliphatic (meth) acrylates, such as trimethylcyclohexyl (meth)acrylate, and isobutylcyclohexyl (meth)acrylate; aryl (meth)acrylates, such as benzyl (meth)acrylate; isobornyl (meth)acrylate; cyclohexyl (meth)acrylate; glycidyl (meth)acrylate; ethyl hexyl (meth) acrylate, benzyl (meth)acrylate or a combination thereof. Methacrylates of methyl, butyl, n-butyl, and isobornyl are preferred. Other monomers such as styrene, alkyl styrene, vinyl toluene and acrylonitrile may be used in addition.

Amine moieties where directed may be provided by alkyl amino alkyl (meth)acrylates such as tert-butylaminoethyl methacrylate.

The crosslinking component of the coating composition of the present invention preferably includes one or more crosslinking agents having at least two isocyanate groups, such as a polyisocyanate crosslinking agent. Any of the conventional aromatic, aliphatic, cycloaliphatic, isocyanates, trifunctional isocyanates and isocyanate functional adducts of a polyol and a diisocyanate can be used. Typically useful diisocyanates are 1,6-hexamethylene diisocyanate, isophorone diisocyanate, 4,4′-biphenylene diisocyanate, toluene diisocyanate, bis cyclohexyl diisocyanate, tetramethylene xylene diisocyanate, ethyl ethylene diisocyanate, 2,3-dimethyl ethylene diisocyanate, 1-methyltrimethylene diisocyanate, 1,3-cyclopentylene diisocyanate, 1,4-cyclohexylene diisocyanate, 1,3-phenylene diisocyanate, 1,5-naphthalene diisocyanate, bis(4-isocyanatocyclohexyl)-methane and 4,4-diisocyanatodiphenyl ether. Prepolymerised forms of these isocyanates are also commonly used to reduce potential exposure hazard of volatile form.

Microgel compositions of the invention may be used in coating compositions with significantly reduced quantities of solvent while maintaining viscosity at a workable level. This has advantages of limiting volatile components and solvents and potentially harmful unreacted reagents, as well as enabling the manufacturer to maintain the favourable mechanical properties conferred by the use of high molecular weight materials. This has significant benefits in regard to both costs and environmental considerations.

Typically the coating composition of the invention will comprise from 5 to 50% of an organic carrier and preferably less than 35%.

The microgels of the present invention may be obtained using controlled “living” prepolymers, macromonomers or can be prepared directly by free radical polymerization of a monomer composition comprising a cross linking monomer and a monounsaturated monomer provided monomer components are chosen which have a significant difference in reactivity and the concentration of components is controlled.

The invention in a further aspect provides a method for preparing a microgel composition comprising:
(i) providing a monomer composition comprising a monounsaturated monomer and a multiunsaturated cross-linking monomer as a solution in an organic solvent, and
(ii) polymerizing the monomer by free radical solution polymerisation wherein the reactivity ratio of the monounsaturated monomer is significantly different from the multiunsaturated monomer and the concentration of the monomer component and the proportion of cross-linking mononer in said monomer composition is controlled whereby a solution of discrete microgel particles of weight average molecular weight of at least 50000 is formed.

The proportion of multi-unsaturated monomer is typically less than 20% by weight of the total monomer component and more preferably less than 15% of weight of the total monomer component.

Most preferably the crosslinking monomer is in the range of from 0.1 to 15% by weight of the total monomer.

The total monomer concentration is typically from 5 to 50% by weight, more preferably from 10 to 50%, still more preferably from 20 to 45% and most preferably 25 to 45% by weight.

The step of polymerizing the monomer composition by free radical solution polymerization will typically involve a free radical initiator.

The invention allows the use of conventional free radical polymerization methods. In these methods, polymerization will be initiated by an initiator and the monomer composition contains at least one monomer with one double bond and at least one multi-unsaturated crosslinker. The keys to prepare such microgels are: a) the ratio between the monomer and crosslinker and the total concentration of the monomers and crosslinkers used; and b) a difference in reactivity of monomer and crosslinker.

Reactivity Ratio

The reactivity ratio (r) of two different monomers is defined as the reactivity of the radical from the first monomer reacting with the first monomer over the reactivity of the radical reacting with the second monomer:
Reactivity Ratio r₁=K₁₁/K₁₂

Similarly,
Reactivity Ratio r₂=K₂₂/K₂₁

Here K₁₁ is the reaction rate of the radical from the first monomer reacting with the first monomer and K₁₂ is the radical from the first monomer reacting with the second monomer.

The conventional approach used to form a crosslinked polymer composition is by choosing similar reactivity ratio r₁ and r₂. When r₁=r₂=1, the crosslinker enters the polymer chain in a statistical manner depending on the concentration. This result in an infinite crosslinked network.

It is preferred that the cross-linker has a higher reactivity than the monounsaturated monomer. Preferably the reactivity ratio (r) of at least one cross-linker to at least one monomer (r1) is at least 1.5. More preferably the ratio is in the range of 1.5-30. On the other hand r2 (the reactivity ratio of the mono-unsaturated monomer) is preferably to be less than 0.5; more preferably less than 0.1.

A particularly preferred example of crosslinking monomers having the required reactivity is ethylene glycol dimethacrylate(EGDMA). The most preferred monounsaturated monomers are acrylates such as isobornyl acrylate, methyl acrylate, butyl acrylate, ethyl hexyl acrylate and higher alkyl acrylates such as C₈ to C₂₀ alkyl acrylates (eg lauryl acrylate).

One (EGDMA) will have higher reactivity to incorporate into a polymer chain than methyl acrylate. Microgels prepared from MA/EGDMA showed much lower viscosity compared with microgel produced from MMA/EGDMA. Here the reactivity of double bond from both MMA and EGDMA are very similar. It was also found that when MMA reacted with ethylene glycol diacrylate (EGDA) under certain conditions, the resultant microgels also give low viscosity properties. Broadly, under specified conditions, when the reactivity of monomers and crosslinker are different, it is possible to produce microgels with special rheology properties that is similar to the one produced as star-microgel using controlled or semi-controlled polymerization methodologies.

The following table lists suitable crosslinkers and monomers with the reactivity values to allow the formation of star-like microgels.

TABLE 1

| Crosslinker | Monomer |
|---|---|
| EGDMA | MA |
| | Vinyl acetate |
| | Vinyl benzoate |
| | Vinyl phenyl acetate |
| | Acrylamide |
| EGDA | Methacrylamide |

In one embodiment of the invention the crosslinking agent component, the monounsaturated monomer component or both, comprise a monomer adapted crosslink with a polymeric binder for use in curing of a coating composition adhesive or elastomer.

In this embodiment the preferred functional groups are selected from hydroxyl, epoxy, carboxylic acid, amine, alkoxysilane and combinations thereof. Examples of functionalised monomers include:
(i) Acids: acrylic acid, methacrylic acid
(ii) Epoxy: glycidyl methacrylate
(iii) Hydroxy: Hydroxy ethyl acrylate, hydroxypropyl acrylate and methacrylate analogues;
(iv) Amino: Dimethyl amino ethyl methacrylate; and
(v) Siloxane: gamma methacryloxy propyl trimethoxy silane and partially or fully higher alkyl substituted analogues.

A functionalised monounsaturated monomer is preferred and hydroxy functionalised monounsaturated monomer is particularly preferred. In this embodiment it is not necessary for the whole monounsaturated monomer component to be functionalised, it may be sufficient in most cases to use a minor proportion of for example from 0.1 to 30 mole % of the relevant composition of functionalised monomer and more preferably from 0.1 to 10 mole %.

While the preferred process is to use an acrylate as the monofunctional momoner, many of the commonly used functionalised monomers may be methacrylates. However as these are generally a minor proportion of the total monomer used (Probably less than 10% of total monofunctional monomer), they may still be incorporated without too much adverse affect.

Concentration of Monomer and Cross-Linker

The optimum combination of total monomer concentration (herein referred to as “T %”) and proportion of crosslinking monomer in the monomer composition (herein referred to as “C %”) can be chosen for a particular system without undue experimentation.

For a given proportion of cross-linker less than 20% by weight the optimum total monomer concentration can be determined by selecting the concentration to form products of molecular weight of at least 10⁵ without gellation. Gellation will occur where either the total monomer concentration or proportion of cross-links is too high. If the total monomer concentration is too low or the proportion of cross-links is too low the resulting product of free radical polymerization will be polymers of relatively low molecular weight.

The polymerization is conducted in a homogeneous solution of an organic solvent. A range of solvents may be used. Suitable solvents may be selected having regard to the nature of the monomers and the need to allow efficient radical polymerization.

Microgels formed in accordance with the process of the invention provide surprisingly unusual rheological properties. For a normal linear polymer, viscosity of a polymer solution is proportional to its molecular weight (MW). That means that with the increase of MW, the viscosity of the polymer will increase. However, we found, those star-shaped microgels behave very differently. The viscosity of a star microgel solution is not proportional to its molecular weight. When MW of the microgel increased from 300K to 1.2 million, the intrinsic viscosity of the solution kept constant at about 0.2 g/dl. Such behaviour is unusual and can provide huge effect in the application of these materials in coating or drug delivery. High molecular weight polymer normally gives better mechanical properties for a coating; however, dilution is normally needed due to its high viscosity. With microgel described here, a low viscosity solution can be achieved at high solid content. Consequently, better coating can be made and less solvent is need for the coating process. In drug delivery, the low viscosity functionalized star microgel can provide a medium for adsorbtion of drug molecules and release them over time during their application.

The microgels may be isolated from the reaction solvent by adding the microgel solutions (preferably dropwise) to a large volume of polar solvent, particularly methanol to induce precipitation. They may then be collected from solution by filtration, using a centrifuge or other suitable techniques for collecting a precipitate.

While the controlled polymerization methods of our prior inventions are efficient and provide high quality microgels the method of this invention allows formation of microgels in a one-pot procedure using low molecular weight components. Further the ability to use conventional polymerization initiators provides even more efficient preparation and avoid the radical capping agents or lewis acids that may reduce stability of the product or require removal.

Throughout the description and claims of this specification, the word “comprise” and variations of the word such as “comprising” and “comprises”, is not intended to exclude other additives or components or integers.

The invention will now be described with reference to the following examples. It is to be understood that the examples are provided by way of illustration of the invention and that they are in no way limiting to the scope of the invention.

### EXAMPLES

The examples are described with reference to the drawings. In the drawings:

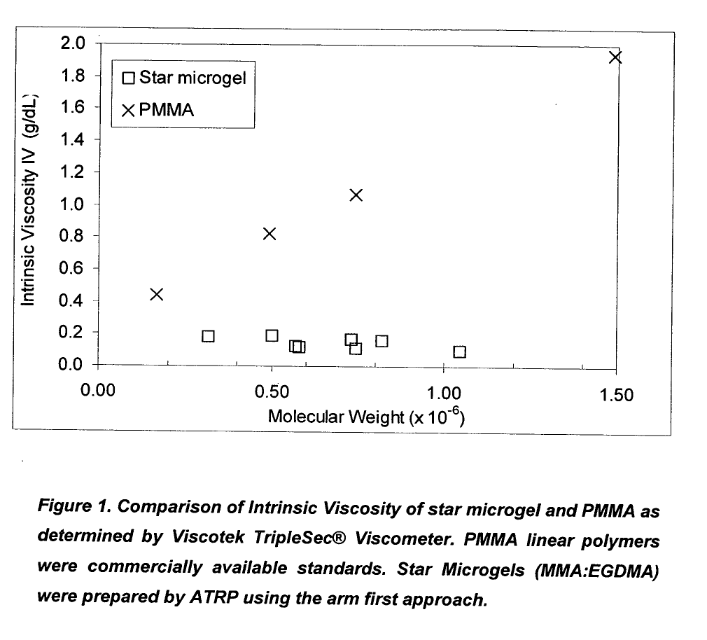

FIG. 1 compares the charge in intrinsic viscosity with molecular weight for a microgel of the invention with PMMA;

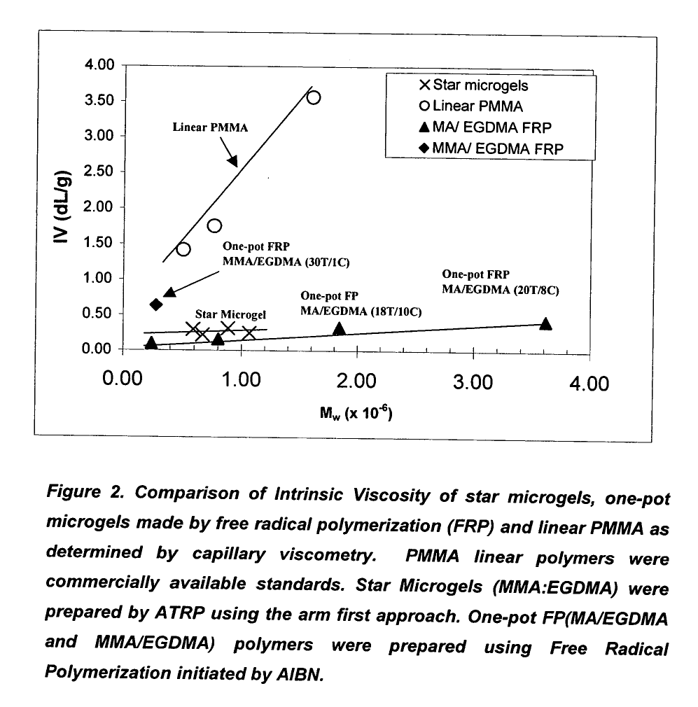

FIG. 2 is a graph comparing intrinsic viscosity of a star microgel, one-pot microgels made by free radical polymerization (FRP) and linear PMMA as determined by capillary viscometry;

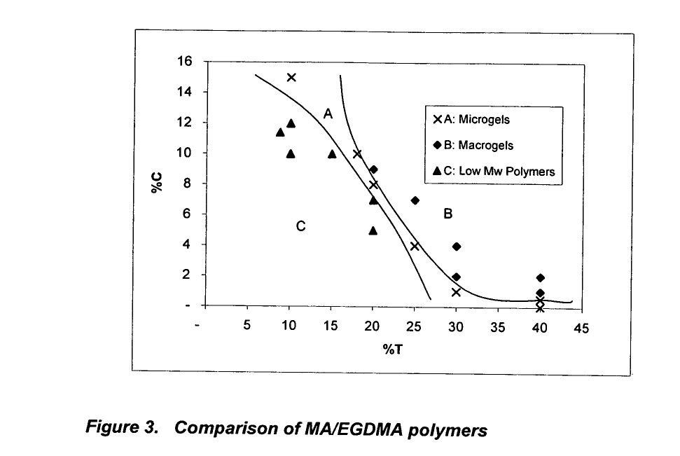

FIG. 3 is a graph showing the formulation regime required for microgel formation;

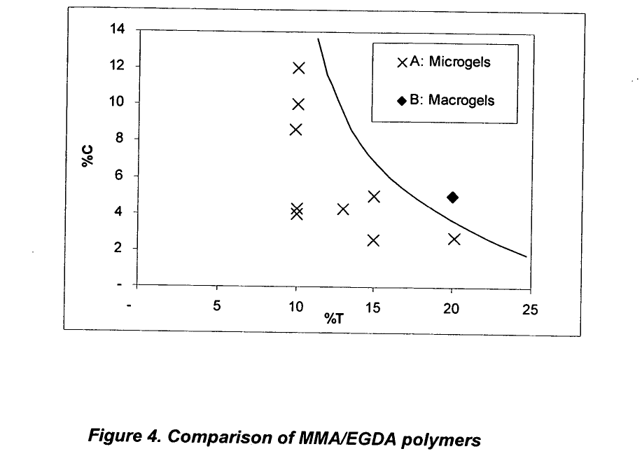

FIG. 4 is a graph showing the comparison of MMA/EGDA polymers;

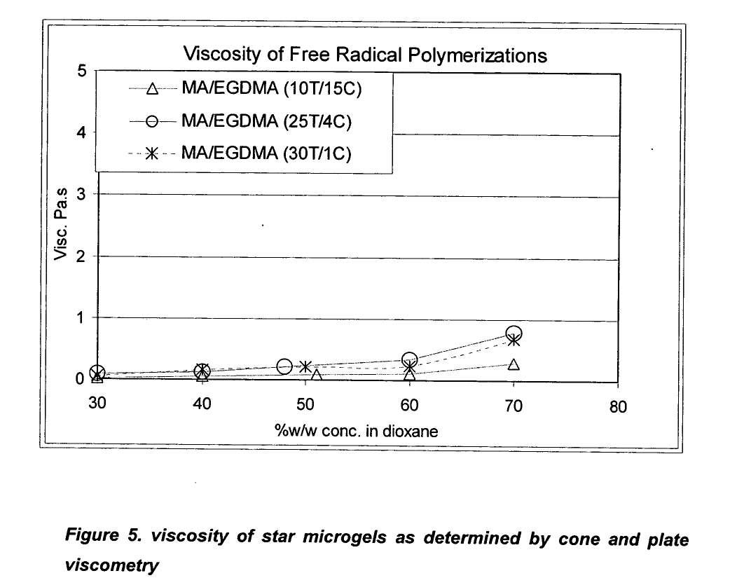

FIG. 5a is a graph showing the comparison of viscosity of star microgels as determined by cone and plate viscometry;

FIG. 5b is a graph showing the comparison of star microgels as determined by cone and plate viscometry; and

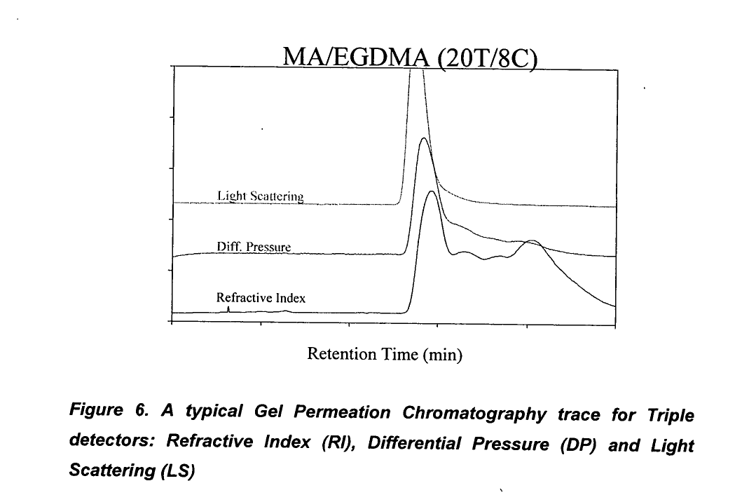

FIG. 6 is a graph of a typical gel permeation chromatography trace for Triple detectors: showing the Refractive Index (RI), the Differential Pressure (DP) and Light Scattering (LS).

### EXAMPLE 1

a) Synthesis of PMMA Macroinitiator ‘Arms’ (PMMA)

A mixture of methyl methacrylate (12.8 mL, 0.12 mol), CuBr (0.17 g, 1.2 mmol), PMDETA (0.25 mL, 1.20 mmol) and p-toluene sulphonyl chloride (p-TsCl, 0.51 g, 2.7 mmol) in p-xylene (17.2 mL) was added to a Schlenk flask and degassed by three freeze-pump-thaw cycles. The flask was then immersed in an oil bath at 80 and heated for 90 h. The reaction mixture was dissolved in THF (100 mL) and precipitated into MeOH (2 L). The precipitate was collected by vacuum filtration and the precipitation repeated to afford PMMA macroinitiator (1) as a white solid (55% yield, Mw 10.0 k). ¹H NMR (CDCl₃, 400 MHz): 7.74 (d, J=8.2 Hz, 0.03H, ArH), 7.36 (d, J=8.0 Hz, 0.03H, ArH), 3.60 (s, 3H, OCH₃), 2.0-1.7 (m, 2H, CH₂), 1.02 (s, 0.45H, CH₃) 0.83 (s, 0.55H, CH₃).

b) Synthesis of PMMA/MMA/EGDMA Star Microgel

A mixture of (1) (0.62 g, 0.062 mmol), EGDMA (0.18 mL, 0.93 mmol), MMA (0.40 mL, 3.7 mmol), CuCl (6.2 mg, 0.062 mmol) and bpy (29 mg, 0.19 mmol) in p-xylene (12.2 mL) was added to a Schlenk flask equipped with a magnetic stirrer. The mixture was degassed by three freeze-pump-thaw cycles and then heated at 100° at atmospheric pressure. After 90 h a sample was taken from the reaction mixture and analyzed directly by GC. The mixture was diluted with THF (20 mL), precipitated into MeOH (1 L) and collected by filtration to afford a colourless solid, which was analyzed by Gel Permeation Chromatography (GPC) (0.98 g, 83% yield, Mw=569,400).

### EXAMPLE 2

Intrinsic Viscosity by Viscotek TriSec® Viscometer

Samples were prepared at 10-20 mg/mL in THF. Size exclusion chromatography (SEC) measurements in THF were carried out using a Waters 717 Plus Autosampler, a Waters 510 HLPC pump equipped with three Phenomenex phenogel columns (500, 10⁴ and 10⁶ Å) in series with a Wyatt Dawn F laser photometer operating at 90° then in parallel with a Waters 410 differential refractometer (RI) and a Viscotek T50A differential viscometer. Data acquisition and analysis were performed with Viscotek TriSEC® software.

Compared to linear polymethyl methacrylate, star microgels were determined to have much lower intrinsic viscosities for polymers of similar molecular weight as illustrated on FIG. 1.

### EXAMPLE 3

Viscosity Test by Capillary Viscometry

The intrinsic viscosity of star microgel, one-pot microgels and linear polymer arm prepared in example 1, 4 and 5, were determined by Ubelhode capillary viscometry. Samples of varying concentrations were prepared in THF and the efflux time measured for each. From the following equations determination of inherent and reduced viscosities versus sample concentration was plotted.
Relative viscosity: ηᵣₑₗ=t/t₀
Specific viscosity: ηₛₚ=[t−t₀]/t₀
Reduced viscosity: η_{red}=ηₛₚ/c
Inherent viscosity: ηᵢₙₕ=1nηᵣₑₗ/c

$$Intrinsic viscosity \text{:} [ η ] = lim \frac{{η}_{red}}{c} = lim \frac{ln ( η / {η}_{0} )}{c}$$

The intrinsic viscosity is determined by extrapolating both the Huggins (reduced viscosity v conc.) and the Kraemer (inherent viscosity v conc.) plots to the y-axis (c=0). A plot of the determined intrinsic viscosities by capillary viscometry for linear polymethyl methacrylate, one-pot microgels and star microgels are shown in FIG. 2.

### EXAMPLE 4

MMA and EGDMA One-Pot Free Radical Polymerization (15% T, 3% C)

A mixture of methyl methacrylate (2.8 g), ethylene glycol dimethacrylate (0.09 g) and 2,2′-azobisisobutyronitrile (AIBN, 0.02 g) in p-xylene (16.2 ml) was added to a Schlenk flask equipped with a magnetic stirrer. The mixture was degassed by three freeze-pump-thaw cycles and then heated at 100 degrees for 90 h. A sample of the mixture was diluted (1:10) in p-xylene and analyzed by Gas Chromatography to determine the conversion of monomers (MMA conversion 92%; EGDMA conversion 88%). A second sample was analyzed by SEC (for MW and viscosity parameters) and the remainder was precipitated into methanol to afford a white solid after filtration (Mₙ 64K; M_{w} 201 K; IV_{w} 0.20 dL/g; Rg_{w} 10.3 nm).

### EXAMPLE 5

MA and EGDMA One Pot Free Radical Polymerization (20% T, 8% C)

A mixture of methyl acrylate (4.8 g), ethylene glycol dimethacrylate (0.42 g) and 2,2′-azobisisobutyronitrile (AIBN, 0.09 g) in p-xylene (21 ml) was added to a Schlenk flask equipped with a magnetic stirrer. The mixture was degassed by three freeze-pump-thaw cycles and then heated at 100 degrees for 90 h. A sample of the mixture was diluted (1:10) in xylene and analyzed by Gas Chromatography (MA conversion 91%; EGDMA conversion 90%). A second sample was analyzed by SEC and the remainder was isolated by removal of the solvent in vacuo (Mₙ 26K; M_{w} 3,615K; IV_{w} 0.49; Rg_{w} 31 nm).

### EXAMPLE 6

MMA and EGDA One Pot Free Radical Polymerization (15% T, 3% C)

A mixture of methyl methacrylate (2.8 g), ethylene glycol diacrylate (0.08 g) and 2,2′-azobisisobutyronitrile (AIBN, 0.05 g) in p-xylene (16.2 ml) was added to a Schlenk flask equipped with a magnetic stirrer. The mixture was degassed by three freeze-pump-thaw cycles and then heated at 100 degrees for 90 h. A sample of the mixture was diluted (1:10) in xylene and analyzed by Gas Chromatography (MMA conversion 90%; EGDA conversion 89%). A second sample was analyzed by SEC and the remainder was isolated by removal of the solvent in vacuo (Mₙ 30K; M_{w} 59K; IV_{w} 0.14 dL/g; Rg_{w} 6.2 nm).

### EXAMPLE 7

Formulations for Preparing MA/EGDMA Microgels

One-pot free radical polymerizations with monomers MA/EGDMA in various formulations according to method described in Example 5 were prepared. The resultant polymers were tested and were found to fall into 3 possible domains: A: microgels, B: macrogels and C: low MW polymers. FIG. 3 shows the formulation regime (% T vs % C) where region A is required for microgel formation.

### EXAMPLE 8

Formulations for Preparing MMA/EGDA Microgels

One-pot free radical polymerizations with monomers MMA/EGDA in various formulations according to method described in Example were prepared. The resultant polymers were tested and were found to fall into 3 possible domains: A: microgels, B: macrogels and C: low MW polymers. FIG. 4 shows the formulation regime (% T vs % C) where region A is required for microgel formation.

### EXAMPLE 9

A Carrimed Rheometer CSL100 with cone and plate geometry (2 cm cone, 2 degree angle, gap between plates=54 um, 25° C., air pressure of 2.5 bar) was used to analyze the viscosities of microgels from examples 4-6. Samples of varying concentration in dioxane (from 30 to 70% w/w) were prepared and left to dissolve overnight. Measurements were obtained using shear stress sweep method, which allows the modification of the end stress. The measured viscosity data plotted against shear rate to determine the viscosity profiles. FIG. 5 shows the viscosity (Pa.s) for these samples as a function of concentration (w/w %).

### EXAMPLE 10

Table 2 listed the molecular properties of microgels measured by SEC from samples prepared from Example 5 and 6.

TABLE 2
Experimental data for one-pot free radical polymerizations.

| | | Monomer/ | | |
|---|---|---|---|---|
| Number | Conc. | Crosslinker | Mn/10⁶ | Mw/10⁶ |
| IN1-30 | 9.9T/8.6C | MMA/EGDA | 49,610 | 282,200 |
| IN1-11 | 10T/10C | MMA/EGDA | 25,900 | 131,500 |
| IN1-35 | 10T/4.3C | MMA/EGDA | 42,240 | 87,520 |
| IN1-36 | 13T/4.3C | MMA/EGDA | 44,820 | 161,100 |
| IN1-29 | 20T/2.7C | MMA/EGDA | 25,130 | 181,200 |
| IN1-38 | 10T/15C | MA/EGDMA | 10,960 | 244,000 |
| IN1-39 | 18T/10C | MA/EGDMA | 38,250 | 1,844,000 |
| IN1-37 | 20T/8C | MA/EGDMA | 25,850 | 3,615,000 |
| IN1-47 | 25T/4C | MA/EGDMA | 7,245 | 802,800 |
| IN1-48 | 40T/0.5 | MA/EGDMA | 313 | 153,000 |

### EXAMPLE 11

FIG. 6 shows GPC traces measured from samples prepared from MA/EGDMA in a formulation of 20 T % and 5 C % by one-pot free radical polymerization.

### EXAMPLE 12

One-Pot Free Radical Polymerization Using MA/EGDMA/HEA (20T/8C/2H)

A mixture of methyl acrylate (3.08 mL, 2.94 g, 34 mmol), 2-hydroxyethyl acrylate (0.059 mL, 0.060 g, 51 mmol), ethylene glycol dimethacrylate (0.25 mL, 0.26 g, 1.3 mmol) and 2,2′-azobisisobutyronitrile (0.057 g, 35 mmol) in p-xylene (12.9 mL) were added to a Schlenk flask equipped with a magnetic stirrer. The mixture was degassed by three freeze-pump-thaw cylces under reduced pressure, sealed and heated at 90° C. for 18 h. The reaction mixture was reduced to dryness and a sample dissolved in THF and analyzed by GPC. Mₙ 8.1 K; M_{w} 273.9K; IV_{w} 0.205; Rg_{w} 9.83; Cone-and-plate viscosity @ 50% solids on dioxane (0.14 Pa.s).

### EXAMPLE 13

a) Preparation of Hydroxy Functional Macromonomers

To a 5-litre round bottom flask equipped with a mechanical stirrer, thermometer, condenser, and heating mantle was added isobutylmethacrylate(IBMA, 545 g), 2-ethylhexyl methacrylate(EHMA, 583.7 g), hydroxyethyl methacrylate(HEMA, 95.6 g) and toluene (939.4 g). The mixture was agitated and heated to reflux under nitrogen. While maintaining the batch at reflux, a mixture of Vazo®88(1,1-azobis(cyanocyclohexane), 1.1 g), HEMA (31.7 g), of toluene (60.1 g), and diaquabis(boron difluorodimethylglyoximato) cobaltate (32 mg) was added over a 10 minute period. This was followed by the addition of a mixture of IBMA (388.6 g), EHMA (561.4 g), HEMA (103.6 g), toluene (179.9 g) and Vazo®88 (4.0 g) to the batch over 240 minutes while maintaining reflux. The batch was then held at reflux for 30 minutes, followed by the addition of a solution of Vazo®88 (1.0 g) in toluene (135.7 g) over 60 minutes whilst maintaining reflux. The batch was held at reflux for 60 minutes and then cooled to room temperature.

b) Microgel Formation (Initiator+Macromonomers)

A solution of EGDMA crosslinker (0.1 g, 0.50 mmol) and AIBN initiator (0.02 g) in p-xylene (10 mL) was degassed under Ar and heated to 60° C. Macromonomer (Example 9a, 0.033 mmol) in THF (lOmL) was added dropwise over 1 h at this temperature under an atmosphere of Ar. The reaction was stirred for a further 1 h, diluted with THF (20 mL), precipitated in methanol and isolated by filtration to afford microgel as a white solid.

### EXAMPLE 14

a) Preparation of Macromonomers (ATRP+Chain Transfer)

To a solution of PMMA macroinitiator (Example 1, 0.6 g, 0.06 mmol) in THF (10 mL), chain transfer agent 5,10,15,20-tetraphenyl-21H, 23H-porphine cobalt (II) (pre-degassed solution, 1.8 g, 2.7 mmol) and MMA (0.27 g, 2.7 mmol) in THF (10 mL) was added via syringe. The reaction was kept at 90° C. for another 2 hours. The product was then diluted with THF and the resultant macromonomer precipitated from methanol.

b) Microgel Formation (Initiator+Macromonomers)

A solution of EGDMA crosslinker (0.1 g, 0.50 mmol) and AIBN initiator (0.02 g) in p-xylene (10 mL) was degassed under Ar and heated to 60° C. Macromonomer (Example 10a, 0.033 mmol) in THF (10 mL) was added dropwise over 1 h at this temperature under an atmosphere of Ar. The reaction was stirred for a further 1 h, diluted with THF (20 mL), precipitated in methanol and isolated by filtration to afford microgel as a white solid.

### EXAMPLE 15

Film Casting Tests

Isocyanate Binder (Dupont ‘IMRON 5000’, 193S Activator, mixture of oligomeric isocyanates, 1 mL) was added to a solution of polymer from in ethyl acetate (25% w/w). A 50 uL aliquot of this mixture was taken, cast onto a glass microscope slide with a plastic frame (10×10×2 mm) and left to cure at ambient temperature. The film was removed from the glass slide and transferred into a centrifuge vial. THF (1 mL) was added to the sample and shaken to solubilize any soluble material. The vials were then centrifuged at 6000 rpm for 5 min. An aliquot of supernatant (0.5 mL) was taken and replaced with THF (0.5 mL). This process was repeated three times to remove any soluble material and the weight of the remaining insoluble material was determined after being dried overnight in a vacuum desiccator. The solubility results of films cast are shown in the following table.

| | | | | Solids | |
|---|---|---|---|---|---|
| | | | | Conc. | |
| Polymer | % T | % C | % H | (% w/w) | % Solubility |
| MA/EGDMA/HEA | 20 | 8 | 2 | 27.6 | 0 |
| MA/EGDMA/HEA | 25 | 2 | 2 | 25.6 | 0 |
| MA/EGDMA/HEA | 20 | 5 | 3 | 24.6 | 0 |
| MA/EGDMA/HEA | 20 | 5 | 4 | 27.1 | 0 |
| MMA/EGDMA/HEMA | 15 | 4 | 5 | 25.0 | 0 |
| MMA/EGDMA | 10 | 10 | 0 | 25.0 | 47.2 |
| ATRP Microgel* | — | — | 0 | 25.0 | 52.2 |

*Sample from star microgel produced by ATRP (Mw 460K, Mw arms 10K)

The results indicate that those films formed containing hydroxy ethyl acrylates (HEA and HEMA) were insoluble in THF. While in comparison those polymers formed without the hydroxyl functionality did not crosslink with isocyanates to form network structures and were solubilised by organic solvent THF.

1. A microgel composition comprising microgel particles prepared by a solution free radical polymerization process and having a weight average molecular weight above 50,000 wherein a 60% w/w solution of the microgel in dioxane has a viscosity of less than 10 Pa.s measured by cone and plate viscometry.

2. A microgel composition according to claim 1 wherein the weight average molecular weight is at least 100,000.

3. A microgel composition according to claim 1 wherein the weight average molecular weight is at least 200,000.

4. A microgel composition according to claim 1 wherein the size of the microgel particles is less than 200 nm in diameter measured by standard GPC methods.

5. A coating composition comprising a microgel composition according to claim 1 wherein the microgel forms at least part of a binder component of the coating composition and the microgel is dissolved in a liquid carrier.

6. A coating composition according to claim 5 wherein the liquid carrier is selected from the group consisting of aromatic hydrocarbons; alcohols; aliphatic hydrocarbons; ketones; and heterocycles.

7. A coating composition according to claim 5 wherein the microgel is present in an amount of from 5 to 90% by weight of the composition.

8. A coating composition according to claim 5 wherein the microgel particles comprise a crosslinked core and arms appended to the core wherein the core is formed from a multiunsaturated monomer and the arms are formed from a monounsaturated monomer.

9. A coating composition according to claim 5 further comprising a second component comprising a crosslinking agent reactive with functional groups present in the binder wherein said reactive functional groups are present in the microgel and/or an additional component of the binder.

10. A coating composition according to claim 9 wherein the crosslinking agent is selected from the group consisting of polyisocyanate, a diepoxy monomer, an amine resin, a siloxane and mixtures of two or more thereof.

11. A coating composition according to claim 9 wherein reactive groups in the binder are selected from the group consisting of hydroxyl, amine, carboxyl, alkoxysilane, epoxy and mixtures thereof.

12. A coating composition according to claim 9 further comprising a binder selected from thermoplastic polymer and thermosetting polymers.

13. A coating composition according to claim 9 comprising a thermosetting polymer binder resin selected from the group consisting of alkyds, polyesters, amino-resins such as melamine formaldehyde resins, acrylic resins, epoxy resins, urethanes and mixtures thereof.

14. A coating composition according to claim 5 further comprising a crosslinking agent adapted to react on curing with functional groups present in at least a portion of the binder component selected from the microgel particles and other optional polymeric binder components.

15. A coating composition according to claim 14 wherein the polymeric binder composition comprises a non-microgel polymeric binder component comprising reactive functional groups for crosslinking with the crosslinking agent.

16. A coating composition according to claim 14 wherein the microgel particles comprise reactive functional groups for crosslinking with said crosslinking agent.

17. A coating composition according to claim 9 wherein the microgel also comprises groups reactive with the crosslinking agent.

18. A coating composition system comprising a first component comprising a coating composition according to claim 5 and a reactive functional group containing polymer and optionally other components such as organic solvents, pigments, fillers, auxiliaries and additives and a second component comprising a crosslinking agent selected from the group consisting of di and/or polyisocyanate; epoxide compounds having at least two epoxide groups per molecule; amino resins; and siloxane crosslinkers.

19. A coating composition according to claim 9 wherein the binder component comprises 50 to 90% by weight of the total composition and the crosslinker components comprises from 10 to 50% by weight of the total composition.

20. A coating composition according to claim 9 comprising an organic carrier in an amount of less than 35% by weight of the total composition.

21. A microgel composition according to claim 1 prepared by polymerising a monomer composition comprising a monounsaturated monomer and a multiunsaturated crosslinking monomer as a solution in an organic solvent by free radical solution polymerisation wherein the reactivity ratio of the monounsaturated monomer is significantly different from the multiunsaturated monomer and the concentration of the monomer component and the proportion of crosslinking monomer in said monomer composition is controlled to provide a solution of discrete microgel particles of weight average molecular weight of at least 50000.

22. A microgel composition according to claim 21 wherein the proportion of multi-unsaturated monomer is less than 15% by weight of the total monomer component.

23. A microgel composition according to claim 21 wherein the total monomer concentration is from 10 to 50% by weight of the total composition.

24. A microgel composition according to claim 21 wherein the total monomer used in preparing the microgel comprises from 25 to 45% by weight of the total composition.

25. A microgel composition according to claim 21 wherein the reactivity ratio (r) of at least one crosslinker to at least one monomer is at least 1.5.

26. A microgel composition according to claim 21 wherein the reactivity ratio of the mono-unsaturated monomer is less than 0.5
